(19) United States
(12) Patent Application Publication
(10) Pub. No.: US 2019/0349506 A1
(43) Pub. Date: Nov. 14, 2019

(54) VIRTUAL REALITY HEAD-MOUNTED APPARATUS

(71) Applicant: ALIBABA GROUP HOLDING LIMITED, Grand Cayman (KY)

(72) Inventors: Hong ZHANG, HANGZHOU (CN); Huanmi YIN, HANGZHOU (CN); Feng LIN, HANGZHOU (CN); Jun WU, HANGZHOU (CN)

(21) Appl. No.: 16/520,561

(22) Filed: Jul. 24, 2019

Related U.S. Application Data
(63) Continuation of application No. PCT/CN2018/077282, filed on Feb. 26, 2018.

(30) Foreign Application Priority Data
Feb. 27, 2017 (CN) 201710108671.3

(51) Int. Cl. H04N 5/225; G02B 27/00

(52) U.S. Cl. CPC H04N 5/2256; G06F 3/013; G02B 27/0093; H04N 5/2257

(57) ABSTRACT

Methods, systems, and apparatus for a virtual reality (VR) head-mounted apparatus are provided. The apparatus includes: a convex lens on a side of the VR head-mounted apparatus close to an eye of a user when the user wears the VR head-mounted apparatus, one or more infrared light sources distributed at a periphery of the convex lens and providing infrared light compensation for the eye of the user corresponding to the convex lens, and a camera associated with the convex lens. A lens of the camera may face the eye of the user corresponding to the convex lens for infrared image acquisition of physiological features of the eye of the user.

### CROSS-REFERENCE TO RELATED APPLICATION

This application is a continuation application of International Patent Application No. PCT/CN2018/077282, filed on Feb. 26, 2018, which is based on and claims priority of the Chinese Patent Application No. 201710108671.3, filed on Feb. 27, 2017 and entitled “VIRTUAL REALITY HEAD-MOUNTED APPARATUS.” The above-referenced applications are incorporated herein by reference in their entirety.

### TECHNICAL FIELD

This application relates generally to virtual reality (VR) technology, and more specifically, to a VR head-mounted apparatus.

### BACKGROUND

VR technology uses a computer graphics system and various control interfaces to generate an interactive environment on a computer and thus provides three-dimensional immersive scenes for a user. Existing technologies may create VR experience through a VR head-mounted apparatus, such as VR glasses or a VR helmet.

However, due to unique characteristics of VR technology, a VR head-mounted apparatus, especially when worn by a user, may have limited internal space and very low brightness, which may pose a challenge for accurate acquisition of an image of an eye of the user for tasks such as identity recognition, eye tracking, etc. Therefore a VR apparatus that can accurately and reliably acquire an image of an eye of a user is desired.

### SUMMARY

In view of the limitations of existing technologies described above, this application provides a VR head-mounted apparatus, which may provide infrared light compensation for an eye of a user, and thus improve the resolution of an image of an eye acquired by a camera and the accuracy of physiological feature in the image.

A first aspect of this specification provides a VR head-mounted apparatus. The VR head-mounted apparatus may comprise a convex lens on a side of the VR head-mounted apparatus close to an eye of a user when the user wears the VR head-mounted apparatus, one or more infrared light sources distributed at a periphery of the convex lens and providing infrared light compensation for the eye of the user corresponding to the convex lens, and a camera associated with the convex lens. A lens of the camera may face the eye of the user corresponding to the convex lens for infrared image acquisition of physiological features of the eye of the user.

In some embodiments, the VR head-mounted apparatus may comprise two convex lenses, and each convex lens may have one or more infrared light sources and a camera distributed at a periphery of the convex lens.

In some embodiments, the one or more infrared light sources may comprise a plurality of infrared light sources uniformly distributed at a periphery of the convex lens.

In some embodiments, the one or more infrared light sources may be installed within a coverage area of a circumscribed rectangle of the convex lens.

In some embodiments, the camera may be located at a side of the convex lens facing the user.

In some embodiments, the camera may be located below the convex lens.

In some embodiments, the camera may be installed in contact with the convex lens.

In some embodiments, the VR head-mounted apparatus may further comprise an apparatus interface electrically connected to an electronic device installed on the VR head-mounted apparatus, and the electronic device may be configured to play VR display content.

The camera and the one or more infrared light sources maybe connected to the apparatus interface through a data line. The camera may be configured to transmit an infrared image to the electronic device through the apparatus interface and the data line.

In some embodiments, the camera may be an infrared radiation (IR) camera or a red-green-blue (RGB) and IR integrated camera.

According to a second aspect, this specification provides a VR viewing apparatus. The VR viewing apparatus may comprise a VR head-mounted apparatus and an electronic device. The VR head-mounted apparatus may comprise two convex lenses on a side of the VR head-mounted apparatus close to an eye of a user when the user wears the VR head-mounted apparatus, one or more infrared light sources distributed at a periphery of at least one of the convex lenses and providing infrared light compensation for the eye of the user corresponding to the convex lens.

The VR head-mounted apparatus may further comprise a camera associated with the at least one of the two convex lenses. A lens of the camera may face the eye of the user corresponding to the at least one of the two convex lenses for infrared image acquisition of physiological features of the eye of the user. The VR head-mounted apparatus may further comprise an apparatus interface connected to the camera and the infrared light sources.

The electronic device may be electronically connected to the apparatus interface. The camera may be configured to transmit an infrared image of the eye of the user to the electronic device.

In some embodiments, the electronic device may be a mobile phone or a tablet installed in the VR head-mounted apparatus.

In some embodiments, the one or more infrared light sources may be installed within a coverage area of a circumscribed rectangle of the at least one of the two convex lenses.

In some embodiments, the camera may be located at a side of the at least one of the two convex lenses facing the user.

In some embodiments, the camera may be located below the at least one of the two convex lenses.

In some embodiments, the camera may be installed in contact with the at least one of the two convex lenses.

In some embodiments, the camera may be an infrared radiation (IR) camera or a red-green-blue (RGB) and IR integrated camera.

The infrared light sources may provide infrared light compensation for an eye of a user corresponding to the convex lens, which allows infrared image acquisition of the eye of the user by a camera to be completed under conditions that are otherwise difficult, if not impossible, for conventional methods to complete. For example, compared to conventional methods, the infrared image acquisition may be completed under a wider range of installation angle of the camera and a wider range of spacing distance of the camera. That provides more flexibility on the arrangement of components within the VR head-mounted apparatus, thereby optimizing space occupation within the VR head-mounted apparatus.

### BRIEF DESCRIPTION OF THE DRAWINGS

FIG. 1 is a side cross-sectional view of a VR helmet provided by an exemplary embodiment of this application.

FIG. 2 is a structural diagram of a VR helmet, observed from a wearer's direction, provided by an exemplary embodiment of this application.

FIG. 3 is a schematic diagram of a positional relationship between an infrared light source and a convex lens provided by an exemplary embodiment of this application.

FIG. 4 is a side cross-sectional view of another VR helmet provided by an exemplary embodiment of this application.

### DETAILED DESCRIPTION OF THE EMBODIMENTS

Specific, non-limiting embodiments of the present invention will be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

Using a VR helmet as an example, detailed structures of a VR head-mounted apparatus of this application are described below through several embodiments.

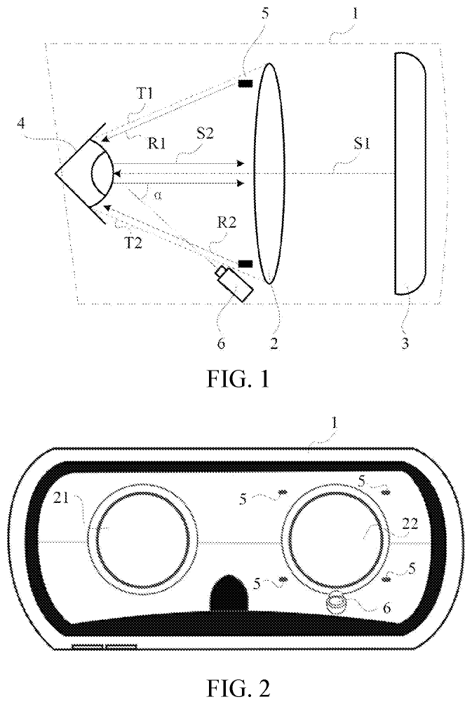

FIG. 1 is a side cross-sectional view of a VR helmet provided by an exemplary embodiment of this application. As shown in FIG. 1, the VR head-mounted apparatus (the VR helmet) 1 may comprise a convex lens 2 and a VR playing component 3. The convex lens 2 may be located between a user (FIG. 1 shows an eye 4 of the user) and the VR playing component 3 in the VR head-mounted apparatus (the VR helmet) 1, so that VR display content played by the VR playing component 3 may, in a form of visible light S1, go through the convex lens 2 and propagate to the eye 4 of the user. The eye 4 of the user may receive the visible light S1 to view the VR display content.

To perform functions such as eye tracking and iris recognition on a user wearing the VR helmet, an infrared image of the eye 4 of the user may be acquired. However, since the VR helmet needs to provide the user with immersive VR experience, the entrance of external light should be minimized, if not eliminated, so light conditions for image acquisition of the eye may be difficult to satisfy since the interior of the VR head-mounted apparatus (the VR helmet) 1 may be dark after the user wears the VR helmet.

Therefore, the VR helmet 1 of this application may comprise one or more infrared light sources 5. The infrared light sources 5 may be distributed at a periphery of at least one convex lens 2, and may provide infrared light compensation (the infrared light sources 5 may emit infrared light such as R1 and R2 to the eye 4, as shown in FIG. 1) for an eye 4 of a user corresponding to the convex lens 2. As shown in FIG. 2, the VR helmet may usually be configured with two convex lenses 2 each corresponding to one eye of a user. The one or more infrared light sources 5 may be distributed at a periphery of one single convex lens 2. For example, the one or more infrared light sources 5 may be distributed at a periphery of a right convex lens 22, as shown in FIG. 2, to provide infrared light compensation for the right eye of the user, and not distributed at a periphery of a left convex lens 21.

When the camera 6 inside the VR helmet 1 performs image acquisition for physiological feature of the eye 4 of the user, the one or more infrared light sources 5 may provide infrared light compensation for the eye 4 to ensure that the eye 4 can reflect sufficient infrared light S2 to be captured by the camera 6 to obtain a clear infrared image. Thus the physiological feature of the eye 4, such as an eyeball position and an iris feature, may be accurately extracted to further implement functions such as eye tracking, iris recognition, etc. The camera 6 may be an infrared radiation (IR) camera or a red-green-blue (RGB) and IR integrated camera, which is not limited in this application.

In the aforementioned embodiment, to avoid blocking the VR display content played by the VR playing component 3 (i.e., to avoid blocking the propagation of the visible light S1), the infrared light sources 5 and the camera 6 need to be, to the fullest extent possible, placed away from a visible area of the convex lens 2 with respect to the eye 4 of the user. The visible area may be indicated, for example, by an upper boundary T1 and a lower boundary T2 as shown in FIG. 1. The one or more infrared light sources 5 may be located at a periphery of the convex lens 2, and the camera 6 may be provided at a top or a bottom of the VR head-mounted apparatus (the VR helmet) 1 (e.g., at a bottom of the VR head-mounted apparatus 1, as shown in FIG. 1), and at a side of the convex lens 2 facing the user (e.g., a left side as shown in FIG. 1).

As described above, when acquiring infrared light S2 emitted from the eye 4 using the camera 6, the camera 6 may need to be placed away from the aforementioned visible range. Meanwhile, while wearing a VR helmet, a user's eye 4 may be maintained at a straight-looking state (i.e., the visible light S2 may propagate substantially horizontally, as shown in FIG. 1). Thus the camera 6 may form an angle α with the infrared light S2. To avoid severe deformation of the acquired image caused by a large angle α, the camera 6 may be disposed in close contact with an edge of the convex lens 2 (in term of at least one of a horizontal distance and a vertical distance). That is, the distance between the camera 6 and the eye 4 may be, to the fullest extent possible, extended to minimize the angle α while all other conditions remain unchanged. Optionally, an angle of the camera 6 may be adjusted within a certain range to adapt to different users using the same VR helmet. During the adjustment, a pupil center of the eye 4 of the user may be, to the fullest extent possible, maintained in a central area of the acquired infrared image to reduce, if not eliminate, image distortion.

In the aforementioned embodiment, installation positions of the one or more infrared light sources 5 and the camera 6 in the VR head-mounted apparatus 1 may be related to each other. For example, as shown in FIG. 2, when the one or more infrared light sources 5 are distributed at a periphery of the right convex lens 22, the camera 6 may be located below the right convex lens 22 (or above the right convex lens 22) in a vertical direction (a top-to-bottom direction in FIG. 2), and may be located at a central position of the right convex lens 22 in a horizontal direction (a left-to-right direction in FIG. 2), so as to reduce or eliminate a horizontal angle between the camera 6 and the eye 4 of the user. In the embodiment shown in FIG. 2, only the right convex lens 22 is provided with the corresponding infrared light sources 5 and camera 6 to perform infrared image acquisition on the right eye of the user. Other configurations are contemplated. For example, only the left convex lens 21 may be provided with the corresponding infrared light sources 5 and camera 6 to perform infrared image acquisition on the left eye of the user, or the left convex lens 21 and the right convex lens 22 may both be provided with the corresponding infrared light sources 5 and cameras 6 simultaneously, which may simultaneously perform infrared image acquisition on two eyes of the user (the infrared light sources 5 and the camera 6 on one side may be selectively turned on for infrared image acquisition on one single eye).

Although the embodiment shown in FIG. 2 has four infrared light sources 5 distributed at a periphery of the right convex lens 22, it is only used as an example here. In the VR helmet of this application, one or more infrared light sources 5 may be distributed at a periphery of each convex lens. The number of infrared light sources 5 is not limited in this application. When there are multiple infrared light sources 5 (e.g., as shown in FIG. 2, four infrared light sources 5 are distributed at a periphery of the right convex lens 22), these infrared light sources 5 may be, to the fullest extent possible, uniformly distributed to provide uniform light compensation for the eye 4.

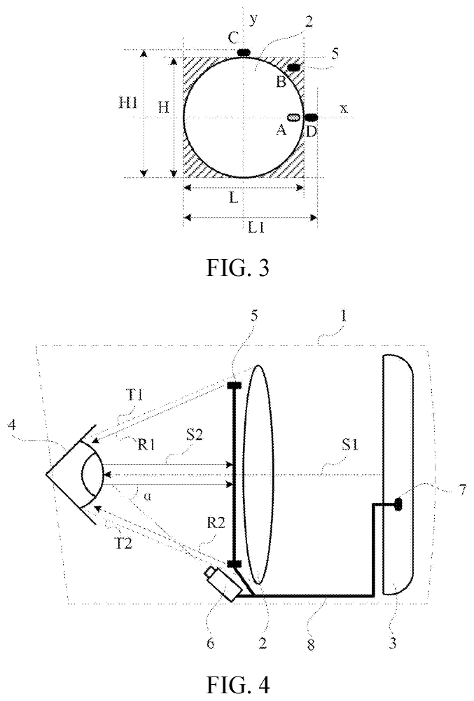

Additionally, since the VR head-mounted apparatus 1 may comprise the convex lens 2, an external size of the VR head-mounted apparatus 1 may be related to the space occupation of the convex lens 2. For example, as shown in FIG. 3, assuming the convex lens 2 has a length of L in a horizontal direction (i.e., x-axis direction in FIG. 3), and a length of H in a vertical direction (i.e., y-axis direction in FIG. 3, when the convex lens 2 is a circle, L and H are equal to a diameter of the circle), the space occupied by the convex lens 2 in the VR head-mounted apparatus 1 may be related to values of L and H. That is, the VR head-mounted apparatus 1 may have a length of at least L in the horizontal direction, and a length of at least H in the vertical direction. When the VR head-mounted apparatus 1 has a substantially rectangular parallelepiped shape, an external size of the VR head-mounted apparatus 1 required by the convex lens 2 may be substantially the same as the external size of the VR head-mounted apparatus 1 required by a circumscribed rectangle of the convex lens 2 of the VR head-mounted apparatus 1 (as shown in FIG. 3, the circumscribed rectangle has a horizontal width of L, and a vertical height of H).

In one embodiment, as shown in FIG. 3, when the infrared light sources 5 are installed within a circumscribed rectangle of the convex lens 2, to avoid blocking the convex lens 2, the infrared light sources 5 should not be located within the convex lens 2 (e.g., point A), but should be located within a shaded area (e.g., point B) shown in FIG. 3. In this case, an external size of the VR head-mounted apparatus 1 required by the infrared light sources 5 may be substantially the same as the external size of the VR head-mounted apparatus 1 required by a circumscribed rectangle of the convex lens 2 (or the convex lens 2 itself). Therefore the infrared light sources 5 do not incur any additional space requirement for the VR head-mounted apparatus 1. That helps to control or even reduce the size of the VR head-mounted apparatus 1 and the associated VR helmet, and prevent the VR helmet from being too bulky and cumbersome.

In another embodiment, as shown in FIG. 3, an infrared light source 5 may be located at point C, then an overall height of a combination of the infrared light source 5 and the convex lens 2 in the vertical direction may increase from H to H1. That is, an external size of the VR head-mounted apparatus 1 in the vertical direction may increase from H to H1, and the VR helmet may become thicker. Similarly, when an infrared light source 5 is located at point D, an overall width of a combination of the infrared light source 5 and the convex lens 2 in the horizontal direction may increase from L to L1. That is, an external size of the VR head-mounted apparatus 1 in the horizontal direction may increase from L to L1, and the VR helmet becomes wider.

Therefore, to the fullest extent possible, the infrared light sources 5 should be located within the circumscribed rectangle of the corresponding convex lens 2 to avoid increasing the external size of the VR head-mounted apparatus 1, and to help to control the space occupied by the VR helmet.

FIG. 4 is a side cross-sectional view of another VR helmet provided by an exemplary embodiment of this application. As shown in FIG. 4, the VR helmet may be a split-style VR head-mounted apparatus, which may comprise an apparatus interface 7 electrically connected to an electronic device, such as a mobile phone or a tablet, installed in the VR head-mounted apparatus 1. By using a processor or a graphics card chip, etc. for rendering, and using a screen component for content displaying, the electronic device may work as the VR playing component 3 in the VR head-mounted apparatus 1.

Further, the camera 6 and the infrared light sources 5 in the VR head-mounted apparatus 1 may be connected to the apparatus interface 7 through a data line 8, so that when the electronic device connected to the apparatus interface 7 issues a switch control instruction, the camera 6 and the infrared light sources 5 may receive the switch control instruction through the apparatus interface 7 and the data line 8, and perform a state switching operation in response to the switch control instruction. In other words, based on the user control to the electronic device or an application program running on the electronic device, the electronic device may send a switch control instruction to the camera 6 and the infrared light sources 5, thereby controlling the infrared light sources 5 to provide infrared light compensation for the eye 4, and controlling the camera 6 to perform infrared image acquisition for the eye 4. That improves the controllability of infrared light compensation and infrared image acquisition.

The switch control instruction may be sent to the camera 6 and the infrared light sources 5 simultaneously. Alternatively, the switch control instruction may also be separately sent to the camera 6 or the infrared light sources 5. For example, the instruction may separately control the camera 6 to perform infrared image acquisition, and separately control the infrared light sources 5 to provide infrared light compensation in case of poor light condition.

Additionally, after the camera 6 completes the infrared image acquisition, if the VR helmet comprises a processing module, the acquired infrared image may be transmitted to the processing module for processing. Alternatively, the camera 6 may transmit, through the apparatus interface 7 and the data line 8, the acquired infrared image to the aforementioned electronic device for processing by the electronic device.

It should also be noted that the terms “include”, “comprise” and any other variants mean to cover the non-exclusive inclusion. Thereby, the process, method, article, or device which include a series of elements not only include those elements, but also include other elements which are not clearly listed, or include the inherent elements of the process, method, article and device. Without further limitation, the element defined by a phrase “include one . . . ” does not exclude other same elements in the process, method, article or device which include the element.

References are made in detail to exemplary embodiments, examples of which are illustrated in the accompanying drawings. The above description refers to the accompanying drawings in which the same numbers in different drawings represent the same or similar elements unless otherwise represented. The implementations set forth in the following description of exemplary embodiments do not represent all implementations consistent with this application. Instead, they are merely examples of apparatuses and methods consistent with aspects related to this application as recited in the appended claims.

The terms used in this application are merely for the purpose of describing specific embodiments, and are not intended to limit this application. The terms “a”, “said” and “the” of singular forms used in this application and the appended claims are also intended to include plural forms, unless otherwise specified in the context clearly. It should also be understood that, the term “and/or” used herein indicates and includes any or all possible combinations of one or more associated listed items.

It should be understood that although the terms such as first, second, and third may be used herein to describe various information, such information should not be limited to these terms. These terms are merely used for distinguishing information of the same type from each other. For example, within the scope of this application, first information may also be referred to as second information, and similarly, second information may also be referred to as first information. Depending on the context, the term “if” as used herein may be interpreted as “when . . . ” or “upon . . . ” or “in response to determining.”

The aforementioned descriptions are merely exemplary embodiments of this application, but are not intended to limit this application. Any modification, equivalent replacement, or improvement made without departing from the spirit and principle of this application should fall within the protection scope of this application.

What is claimed is:

1. A virtual reality (VR) head-mounted apparatus, comprising:
a convex lens on a side of the VR head-mounted apparatus close to an eye of a user when the user wears the VR head-mounted apparatus;
one or more infrared light sources distributed at a periphery of the convex lens and configured to provide infrared light compensation for the eye of the user corresponding to the convex lens; and
a camera associated with the convex lens, a lens of the camera facing the eye of the user corresponding to the convex lens for infrared image acquisition of physiological features of the eye of the user.

2. The apparatus of claim 1, wherein the apparatus comprises two convex lenses, and each convex lens has one or more infrared light sources and a camera distributed at a periphery of the convex lens.

3. The apparatus of claim 1, wherein the one or more infrared light sources comprise a plurality of infrared light sources uniformly distributed at the periphery of the convex lens.

4. The apparatus of claim 1, wherein the one or more infrared light sources are installed within a coverage area of a circumscribed rectangle of the convex lens.

5. The apparatus of claim 1, wherein the camera is located at a side of the convex lens facing the user.

6. The apparatus of claim 5, wherein the camera is located below the convex lens.

7. The apparatus of claim 5, wherein the camera is installed in contact with the convex lens.

8. The apparatus of claim 1, further comprising:
an apparatus interface electrically connected to an electronic device installed on the apparatus, the electronic device being configured to play VR display content,
wherein the camera and the one or more infrared light sources are connected to the apparatus interface through a data line, and wherein the camera is configured to transmit an infrared image to the electronic device through the apparatus interface and the data line.

9. The apparatus of claim 1, wherein the cameras is an infrared radiation (IR) camera or a red-green-blue (RGB) and IR integrated camera.

10. A virtual reality (VR) viewing apparatus, comprising:
a VR head-mounted apparatus, comprising:
two convex lenses on a side of the VR head-mounted apparatus close to an eye of a user when the user wears the VR head-mounted apparatus;
one or more infrared light sources distributed at a periphery of at least one of the two convex lenses and providing infrared light compensation for the eye of the user corresponding to the convex lens;
a camera associated with the at least one of the two convex lenses, a lens of the camera facing the eye of the user corresponding to the at least one of the two convex lenses for infrared image acquisition of physiological features of the eye of the user; and
an apparatus interface connected to the camera and the infrared light sources, and
an electronic device electronically connected to the apparatus interface, and
wherein the camera is configured to transmit an infrared image of the eye of the user to the electronic device.

11. The VR viewing apparatus of claim 10, wherein the electronic device is a mobile phone or a tablet installed in the VR head-mounted apparatus.

12. The VR viewing apparatus of claim 10, wherein the one or more infrared light sources are installed within a coverage area of a circumscribed rectangle of the at least one of the two convex lenses.

13. The VR viewing apparatus of claim 10, wherein the camera is located at a side of the at least one of the two convex lenses facing the user.

14. The VR viewing apparatus of claim 13, wherein the camera is located below the at least one of the two convex lenses.

15. The VR viewing apparatus of claim 13, wherein the camera is installed in contact with the at least one of the two convex lenses.

16. The VR viewing apparatus of claim 10, wherein the camera is an infrared radiation (IR) camera or a red-green-blue (RGB) and IR integrated camera.
